(19) United States
(12) Patent Application Publication
(10) Pub. No.: US 2020/0150867 A1
(43) Pub. Date: May 14, 2020

(54) MEMORY SYSTEM AND OPERATION METHOD THEREOF

(71) Applicant: SK hynix Inc., Icheon-si Gyeonggi-do (KR)

(72) Inventor: Eu-Joon BYUN, Yongin-si Gyeonggi-do (KR)

(73) Assignee: SK hynix Inc., Icheon-si Gyeonggi-do (KR)

(21) Appl. No.: 16/597,327

(22) Filed: Oct. 9, 2019

(30) Foreign Application Priority Data
Nov. 13, 2018 (KR) 10-2018-0138756

(51) Int. Cl. G06F 3/06

(52) U.S. Cl. CPC G06F 3/064; G06F 3/0659; G06F 3/0679; G06F 3/0611

(57) ABSTRACT

A memory system includes a memory device and a controller suitable for controlling the memory device. The memory device includes a plurality of superblocks each including first and second sub-superblocks. The controller includes a processor suitable for controlling the memory device to write data having different attributes to the first and second sub-superblocks in parallel.

### CROSS-REFERENCE TO RELATED APPLICATION

This application claims priority under 35 U.S.C. § 119 to Korean Patent Application No. 10-2018-0138756, filed on Nov. 13, 2018, which is incorporated herein by reference in its entirety.

### BACKGROUND

### 1. Field

Exemplary embodiments relate to a memory system, and more particularly, to a memory system including a memory device and a method of operation thereof.

### 2. Discussion of the Related Art

The computer environment paradigm has been transitioning to ubiquitous computing, which enables computing systems to be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Because they have no moving parts, memory systems provide advantages such as excellent stability and durability, high information access speed, and low power consumption. Examples of memory systems having such advantages include universal serial bus (USB) memory devices, memory cards having various interfaces, and solid state drives (SSD).

### SUMMARY

Various embodiments are directed to a memory system capable of improving interleaving performance of a superblock, and an operation method thereof.

In an embodiment, a memory system may include a memory device and a controller suitable for controlling the memory device. The memory device may include a plurality of superblocks each including first and second sub-superblocks, and the controller may include a processor suitable for controlling the memory device to write data having different attributes to the first and second sub-superblocks in parallel.

In an embodiment, an operation method of a memory system having a memory device includes receiving a write request and user data from a host and generating metadata associated with the user data. The operation method also includes writing the user data to a first sub-superblock of the memory device. the operation method further includes writing the metadata to a second sub-superblock of the memory device, wherein the user data and the metadata are written in parallel.

In an embodiment, an operation method of a memory system having a memory device includes receiving a write request and user data from a host. The operation method also includes generating first metadata and second metadata, which are associated with the user data. The operation method further includes writing, in parallel, the user data to a full superblock, the first metadata to a first sub-superblock, and the second metadata to a second sub-superblock.

### BRIEF DESCRIPTION OF THE DRAWINGS

FIG. 1 schematically illustrates a structure of a memory system in accordance with an embodiment.

FIG. 2 schematically illustrates a configuration of a plurality of dies included in a memory device.

FIG. 3 is a timing diagram for describing a parallel operation of a memory device in accordance with the embodiment.

FIG. 4 schematically illustrates a configuration of a plurality of planes included in a memory device in accordance with the embodiment.

FIG. 5 is a timing diagram illustrating an operation of writing user data and metadata in the example illustrated by FIG. 4.

FIG. 6 illustrates a superblock table in accordance with an embodiment.

FIG. 7 illustrates a sub-superblock table in accordance with an embodiment.

FIGS. 8 and 9 are flowcharts illustrating an operation method of a memory system in accordance with an embodiment.

FIG. 10 illustrates user data sub-superblocks and a metadata sub-superblock.

FIG. 11 is a timing diagram when user data and metadata are written in accordance with an embodiment.

FIG. 12 illustrates a sub-superblock table in accordance with an embodiment.

FIGS. 13 and 14 are flowcharts illustrating an operation method of a memory system in accordance with an embodiment.

FIGS. 15 to 23 schematically illustrate other examples of a data processing system including the memory system in accordance with the embodiment.

### DETAILED DESCRIPTION

Hereafter, embodiments of the present teachings are described with reference to the accompanying drawings. Descriptions focus on details related to understanding specific operations in accordance with embodiments. Descriptions related to other detailed are in some instances omitted in order not to unnecessarily obscure presented descriptions.

Hereafter, embodiments are described in detail with reference to the accompanying drawings.

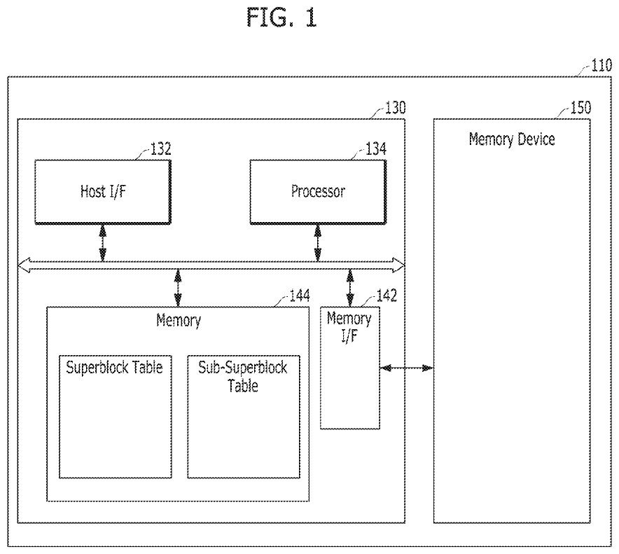

FIG. 1 schematically illustrates a structure of a memory system 110 in accordance with an embodiment.

The memory system 110 may operate in response to a request of a host. In particular, the memory system 110 may store data accessed by a host. That is, the memory system 110 may be used as a main memory device or secondary memory device of the host.

The memory system 110 may operate to store data for the host 102 in response to a request of the host 102. A non-exhaustive list of examples of the memory system 110 may include a solid state drive (SSD), a multi-media card (MMC), a secure digital (SD) card, a universal storage bus (USB) device, a universal flash storage (UFS) device, compact flash (CF) card, a smart media card (SMC), a personal computer memory card international association (PCMCIA) card, and memory stick. The MMC may include an embedded MMC (eMMC), reduced size MMC (RS-MMC) and micro-MMC, and the. The SD card may include a mini-SD card and micro-SD card.

The memory system 110 may be embodied by various types of storage devices. Examples of such storage devices may include, but are not limited to: volatile memory devices, such as a DRAM dynamic random access memory (DRAM) and a static RAM (SRAM); and nonvolatile memory devices, such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM or ReRAM), and a flash memory. The flash memory may have a 3-dimensional (3D) stack structure.

The memory system 110 may include a controller 130 and a memory device 150.

The controller 130 and the memory device 150 may be integrated into a single semiconductor device. For example, the controller 130 and the memory device 150 may be integrated as one semiconductor device to constitute a solid state drive (SSD). When the memory system 110 is used as an SSD, the operating speed of the host 102 connected to the memory system 110 can be improved. In addition, the controller 130 and the memory device 150 may be integrated as one semiconductor device to constitute a memory card. For example, the controller 130 and the memory device 150 may constitute a memory card such as a personal computer memory card international association (PCMCIA) card, compact flash (CF) card, smart media (SM) card, memory stick, multimedia card (MMC) including reduced size MMC (RS-MMC) and micro-MMC, secure digital (SD) card including mini-SD, micro-SD and SDHC, or universal flash storage (UFS) device.

A non-exhaustive list of application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 150 may store data provided from the host 102 through a write operation and may provide data stored therein to the host 102 through a read operation. The memory device 150 may be a nonvolatile memory device, for example, a flash memory with a three-dimensional stack structure.

Each of the memory blocks included in the memory device 150 may include a single-level cell (SLC) memory block, a multi-level cell (MLC) memory block, a triple-level cell (TLC) memory block, a quadruple-level cell (QLC) memory block, and a multiple-level cell memory block capable of storing five or more bits in one memory cell, depending on the number of bits which can be stored in one memory cell.

Hereafter, a configuration in which the memory device 150 is implemented with a nonvolatile memory, such as a NAND flash memory, is exemplified for convenience of description. However, embodiments are not limited to such a configuration, and the memory device 150 may be implemented as a NOR-type flash memory, a hybrid flash memory having at least two or more types of memory cells mixed therein, or a one-NAND flash memory having a controller embedded in a memory chip. Furthermore, the memory device 150 in accordance with an embodiment may be implemented as a flash memory device having a charge storage layer formed of a conductive floating gate or a charge trap flash (CTF) memory device having a charge storage layer formed of a dielectric layer. The memory device 150 may be implemented as any one of memories such as a phase change random access memory (PCRAM), a resistive random access memory (RRAM or ReRAM), a ferroelectric random access memory (FRAM), and a spin transfer torque magnetic random access memory (STT-RAM or STT-MRAM).

The controller 130 may control the memory device 150 in response to a request from the host 102. For example, the controller 130 may provide data read from the memory device 150 to the host 102 and may store data provided from the host 102 into the memory device 150. For this operation, the controller 130 may control read, program, and erase operations of the memory device 150.

More specifically, the controller 130 may include a host interface (I/F) 132, a processor 134, a memory I/F 142, and a memory 144.

The host interface 132 may be configured to process a command and data of the host 102, and may communicate with the host 102 through one or more of various interface protocols, such as universal serial bus (USB), multi-media card (MMC), peripheral component interconnect-express (PCI-e or PCIe), small computer system interface (SCSI), serial-attached SCSI (SAS), serial advanced technology attachment (SATA), parallel advanced technology attachment (PATA), enhanced small disk interface (ESDI), and integrated drive electronics (IDE).

The host interface 132 may be driven through firmware, referred to as a host interface layer (HIL), in order to exchange data with the host.

The memory I/F 142 may serve as a memory/storage interface for interfacing the controller 130 and the memory device 150 such that the controller 130 controls the memory device 150 in response to a request from the host 102. When the memory device 150 is a flash memory or specifically a NAND flash memory, the memory I/F 142 may generate a control signal for the memory device 150 and process data to be provided to the memory device 150 under the control of the processor 134. The memory I/F 142 may work as an interface (e.g., a NAND flash interface) for processing a command and data between the controller 130 and the memory device 150. Specifically, the memory I/F 142 may support data transfer between the controller 130 and the memory device 150.

The memory interface 142 may be driven through firmware referred to as a flash interface layer (FIL) in order to exchange data with the memory device 150.

The memory 144 may serve as a working memory of the memory system 110 and the controller 130, and may store data for driving the memory system 110 and the controller 130. The controller 130 may control the memory device 150 to perform read, program, and erase operations in response to a request from the host 102. The controller 130 may provide data read from the memory device 150 to the host 102 and may store data provided from the host 102 into the memory device 150. The memory 144 may store data related to the controller 130 and the memory device 150 performing these operations.

The memory 144 may be embodied by a volatile memory. For example, the memory 144 may be embodied by static random access memory (SRAM) or dynamic random access memory (DRAM). The memory 144 may be disposed within or outside of the controller 130. FIG. 1 exemplifies the memory 144 disposed within the controller 130. In an embodiment, the memory 144 may be embodied by an external volatile memory having a memory interface transferring data between the memory 144 and the controller 130.

As described above, the memory 144 may store data used for performing a data write/read operation between the host and the memory device 150 and data when the data write/read operation is performed. In order to store such data, the memory 144 may include a program memory, data memory, write buffer/cache, read buffer/cache, data buffer/cache, map buffer/cache, or the like.

The processor 134 may control the overall operations of the memory system 110. The processor 134 may drive firmware to control the overall operations of the memory system 110. The firmware may be referred to as flash translation layer (FTL). Also, the processor 134 may be realized as a microprocessor or a central processing unit (CPU).

The controller 130 may perform an operation requested by the host 102 through the processor 134, which is realized as a microprocessor or a CPU. In other words, the controller 130 may perform a command operation corresponding to a command received from the host 102. The controller 130 may perform a foreground operation as the command operation corresponding to the command received from the host 102. For example, the controller 130 may perform a program operation corresponding to a write command, a read operation corresponding to a read command, an erase operation corresponding to an erase command, and a parameter set operation corresponding to a set parameter command or a set feature command.

Also, the controller 130 may perform a background operation on the memory device 150 through the processor 134, which is realized as a microprocessor or a CPU. The background operation performed on the memory device 150 may include an operation of copying and processing data stored in some memory blocks among the memory blocks 152 to 156 of the memory device 150 into other memory blocks, e.g., a garbage collection (GC) operation, an operation of swapping between the memory blocks 152 to 156 or between the data of the memory blocks 152 to 156, e.g., a wear-leveling (WL) operation, an operation of storing map data stored in the controller 130 in the memory blocks 152 to 156, e.g., a map flush operation, or an operation of managing bad blocks of the memory device 150, e.g., a bad block management operation of detecting and processing bad blocks among the memory blocks 152 to 156.

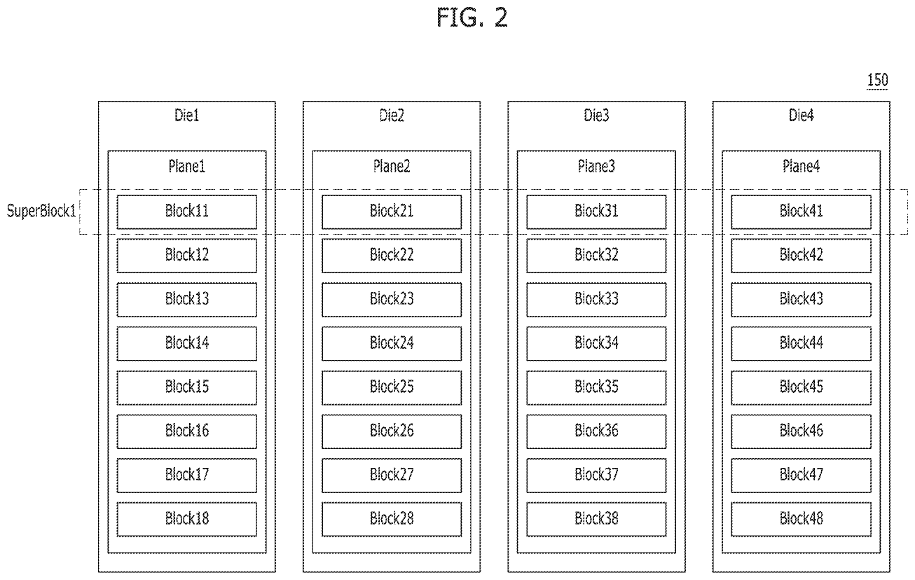

FIG. 2 illustrates a plurality of planes Plane1 to Plane4 included in the memory device 150.

The memory device 150 may include one or more memory dies. Each of the memory dies may include one or more planes. FIG. 2 illustrates four dies Die1 to Die4 each including one plane. That is, the memory device 150 of FIG. 2 may include four planes Plane1 to Plane4.

Each of the planes Plane1 to Plane4 may include a plurality of memory blocks. Each of the memory blocks Block11 to Block48 may include a plurality of pages (not illustrated), and each of the pages may include a plurality of memory cells (not illustrated) coupled to word lines.

Here, one memory block may correspond to the smallest unit which can be physically erased at once. One page may correspond to the smallest unit which can be written or read at once.

The plurality of planes Plane1 to Plane4 may operate independently of each other. In order to improve the parallel processing performance of the memory system 110, the controller 130 may configure one superblock by logically coupling memory blocks included in the respective planes Plane1 to Plane4. FIG. 2 illustrates a first superblock Superblock1 composed of 11th, 21st, 31st, and 41st blocks Block11, Block21, Block 31, and Block 41 among the memory blocks included in the respective planes Plane1 to Plane4.

The controller 130 may access the superblocks in parallel.

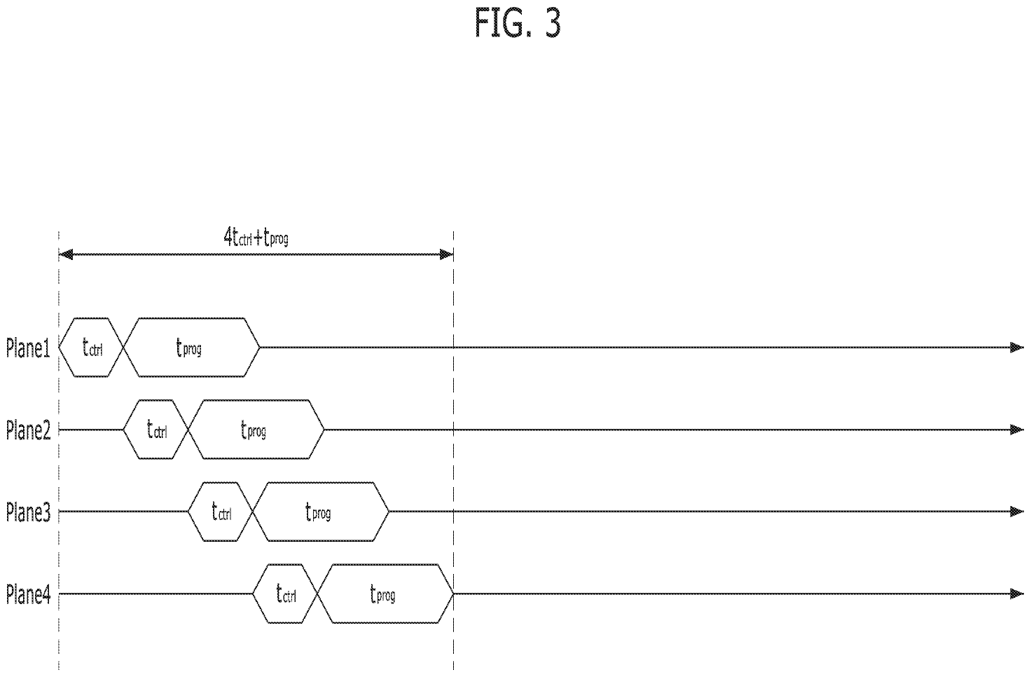

FIG. 3 is a timing diagram for describing a parallel operation of the memory device 150 by taking a write operation as an example.

In FIG. 3, t_{ctrl} represents the time required for the memory I/F 142 to provide a command and data to the memory device 150, and t_{prog} represents the time required for performing a write operation on one page.

The processor 134 may interleave write data and pair commands with the interleaved write data. The processor 134 may provide the paired commands to the respective dies Die1 to Die4 through the memory I/F 142. Each of the dies Die1 to Die4 may acquire a paired command and provide the paired command to a plane therein. The plurality of planes Plane1 to Plane4 may perform command operations in parallel in response to the paired commands, respectively.

Referring to FIG. 3, when the plurality of planes Plane1 to Plane4 perform write operations on a total of four pages in parallel, a time interval of (4t_{ctrl}+t_{prog}) may be required. By comparison, when one plane performs write operations on four pages, a longer time interval of (4t_{ctrl}+4t_{prog}) may be required. That is, the controller 130 may configure superblocks to access the memory device 150 in parallel, thereby improving the performance of the memory system 110.

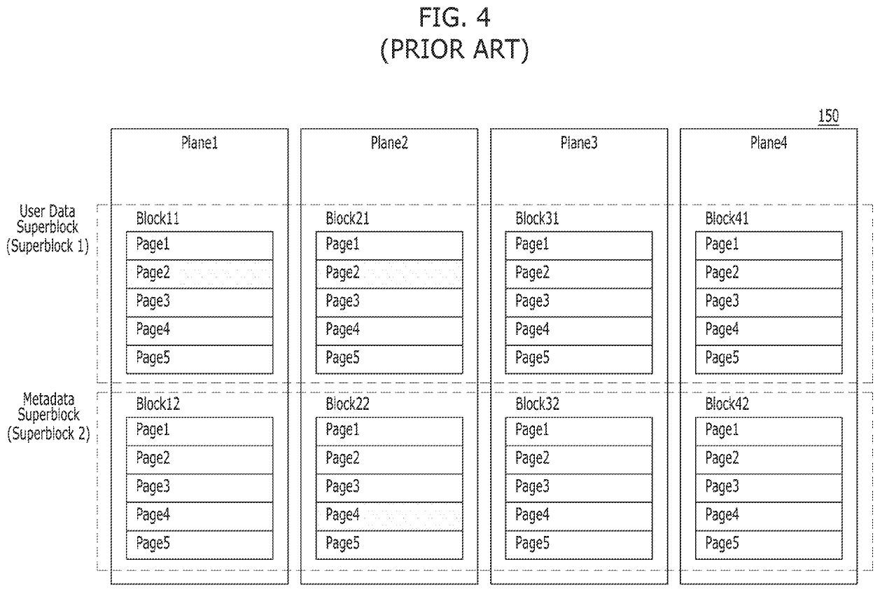

FIG. 4 schematically illustrates a configuration of the plurality of planes Plane1 to Plane4 included in the memory device 150.

When user data are written in response to a write request from the host, the processor 134 may generate metadata associated with the user data. For example, the processor 134 may generate map data for accessing the user data. The processor 134 may control the memory device 150 to write the user data and the metadata to different superblocks.

FIG. 4 illustrates that a first superblock is used as a user data superblock and a second superblock is used as a metadata superblock, according to a related art.

The controller 130 may control the memory device 150 to write the user data and the metadata.

Each of the memory blocks included in each of the superblocks may include a plurality of pages Page1 to Page5. In this specification, a unit obtained by logically coupling pages included in the respective memory blocks constituting the superblock may be defined as a superpage.

The processor 134 may interleave write data to be written to the respective superblocks in order of superpage. For example, the controller 130 may interleave the write data such that the write data are written to first pages of the 11th to 41st blocks constituting the first superblock and then written to second pages of the 11th to 41st blocks.

The processor 134 may pair a write command with the interleaved data to write the interleaved data, and provide the paired command to at least any one of the dies Die1 to Die4 of the memory device 150.

In FIG. 4, broken lines indicate pages to which user data and metadata are to be written according to a write request from the host in order of superpage. In the example of FIG. 4, the user data may be written to the second page Page2 of the 11th block Block11 and the second page Page2 of the 21st block Block21 and the metadata may be written to the fourth page Page4 of the 22nd block Block22. That is, the user data may be written in the first and second planes, and the metadata may be written in the second plane.

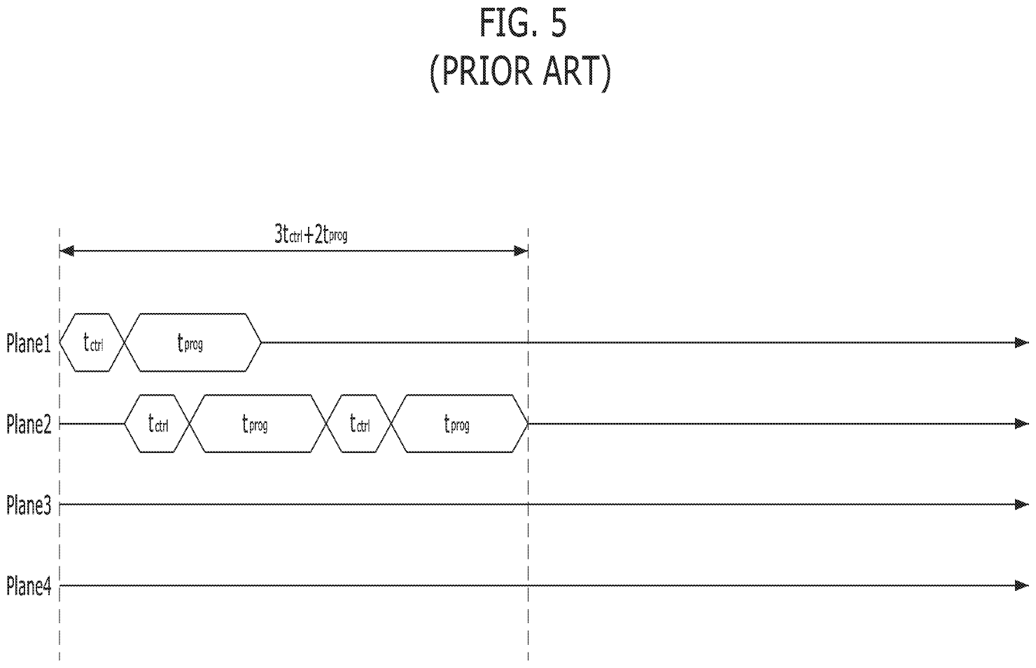

FIG. 5 is a timing diagram illustrating the operation of writing the user data and the metadata for the example of FIG. 4.

The controller 130 may interleave the user data, and provide user data write commands to the first and second planes, respectively. The first and second planes may operate in parallel in response to the user data write commands.

While a plane performs a program operation on a certain page, that plane cannot perform a program operation on another page at the same time. Therefore, the controller 130 may provide a metadata write command to the second plane after the user data write operation is completed in the second plane. That is, when user data and metadata are written in response to one write request, the user data and the metadata may be written to the same plane according to the write order of the superblocks. When the user data and the metadata are written to the same plane, the memory device 150 cannot write the user data and the metadata in parallel. Thus, the memory device 150 may not exhibit the parallel processing performance as much as is possible. Referring to FIG. 5, a time of (3t_{ctrl}+2t_{prog}) may be required to write the user data and the metadata.

In accordance with an embodiment which is described below, the processor 134 may divide one superblock into a plurality of sub-superblocks based on memory dies and may control the memory device 150 to write data having different attributes to the respective sub-superblocks. For example, the processor 134 may interleave user data and metadata such that the user data are written to a first sub-superblock and the metadata are written to a second sub-superblock, and provide a write command to the memory device 150. Because the memory device 150 can write the user data and the metadata in parallel at the same time, the parallel processing performance of the memory device 150 can be improved.

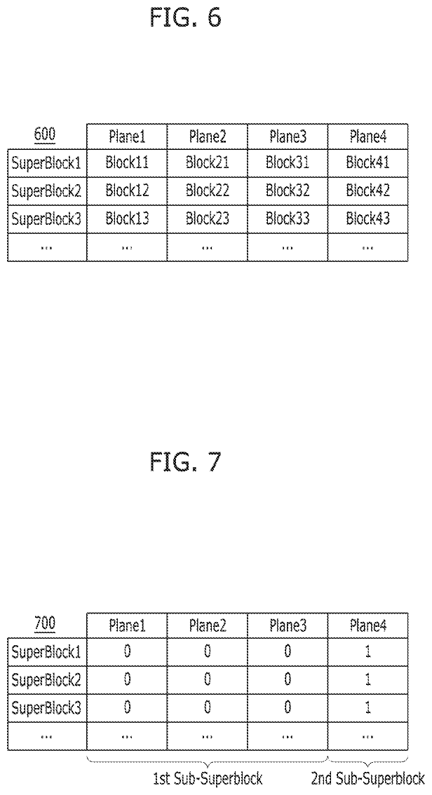

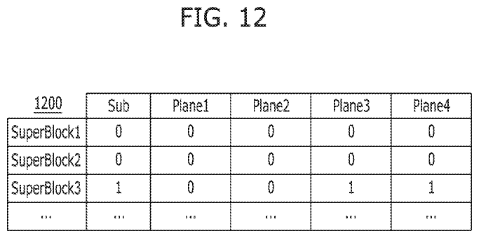

Referring back to FIG. 1, the memory 144 may store a superblock table and a sub-superblock table to store memory block information constituting the respective sub-superblocks. The superblock table is described in detail with reference to FIG. 6, and various embodiments of the sub-superblock table are described in detail with reference to FIGS. 7 and 12.

FIG. 6 illustrates a superblock table 600 in accordance with an embodiment.

The superblock table 600 may store memory block information constituting each of the superblocks for each plane. The superblock table 600 of FIG. 6 may correspond to the superblock table of FIG. 1.

The superblock table 600 may include the identifiers of the respective superblocks as indexes. Entries for each of the indexes may use the identifiers of the respective planes as fields and store memory block information therein. For example, information of the 11th, 21st, 31st, and 41st blocks Block11, Block21, Block31, and Block41 may be stored in the entries corresponding to the first superblock Superblock1 for the respective planes.

FIG. 7 illustrates a sub-superblock table 700 in accordance with an embodiment. The sub-superblock table 700 of FIG. 7 may correspond to the sub-superblock table of FIG. 1.

In accordance with an embodiment, one superblock may be divided into first and second sub-superblocks. In accordance with a further embodiment, each superblock may be divided into first and second sub-superblocks.

The sub-superblock table 700 may include the identifiers of the respective superblocks as indexes thereof. Entries for each of the indexes may use the identifiers of the respective planes as fields and store bit values therein. The bit values may be stored in order to distinguish between the first and second sub-superblocks included in each of the superblocks. For example, when a memory block belonging to a certain plane constitutes the first sub-superblock, a bit value ‘0’ may be stored in the corresponding entry. Furthermore, when a memory block belonging to a certain plane constitutes the second sub-superblock, a bit value ‘1’ may be stored in the corresponding entry.

The memory blocks constituting the first and second sub-superblocks may be decided in advance. In the example of FIG. 7, the memory blocks belonging to the first to third planes Plane1 to Plane3 may constitute the first sub-superblock, and the memory blocks belonging to the fourth plane Plane4 may constitute the second sub-superblock.

For convenience of description, an M^{th} sub-superblock of an N^{th} superblock may be defined as a superblock N-M. In the example of FIG. 7, a superblock 2-1 may indicate a sub-superblock constituted by the memory blocks included in the first to third planes among the memory blocks constituting the second superblock. Referring to FIG. 6, the superblock 2-1 may indicate a sub-superblock constituted by the 12th, 22nd, and 32nd blocks Block12, Block22, and Block32.

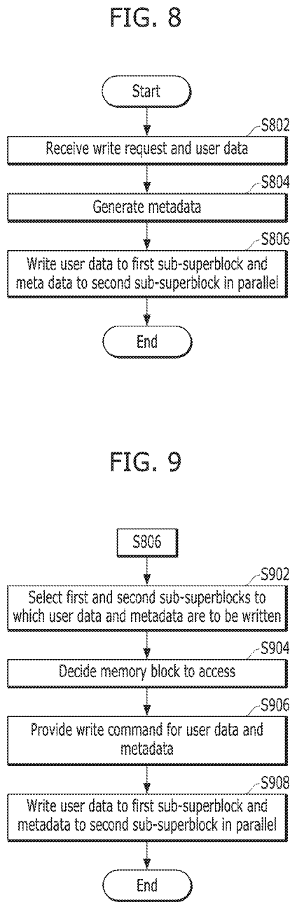

FIG. 8 is a flowchart illustrating an operation method of the memory system 110 in accordance with an embodiment.

In step S802, the processor 134 may receive a write request and user data to be written from the host through the host I/F 132.

In step S804, the processor 134 may generate metadata associated with the user data.

In step S806, the processor 134 may interleave the user data and the metadata such that the user data are written to a first sub-superblock and the metadata are written to a second sub-superblock, and provide a write command to the memory device 150. The memory device 150 may write the user data and the metadata in parallel in response to the write command.

FIG. 9 is a flowchart illustrating detailed operations for step S806 of FIG. 8.

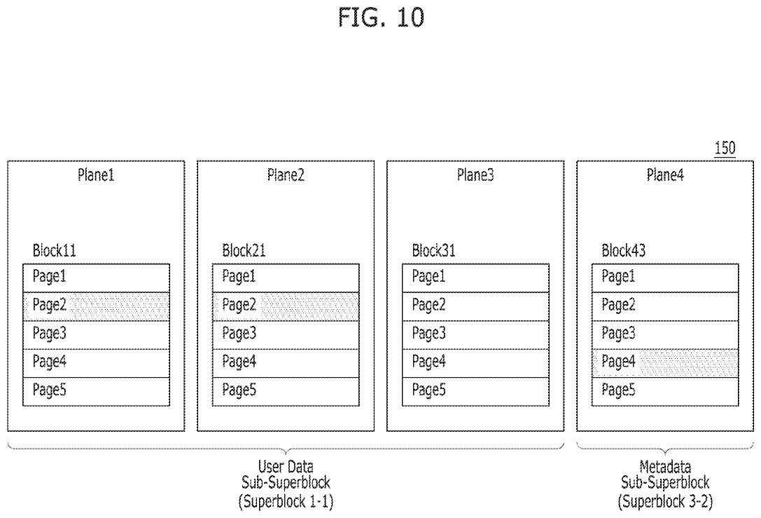

FIG. 10 illustrates user data sub-superblocks and a metadata sub-superblock.

Referring to FIG. 9, the processor 134 may select the first and second sub-superblocks to which the user data and the metadata are to be written, in step S902.

Specifically, when first and second open sub-superblocks are present at the moment, the processor 134 may select the first and second sub-superblocks. On the other hand, when the first and second open sub-superblocks are not present at the moment, the processor 134 may select first and second sub-superblocks in an erase state. In the example of FIG. 10, the selected first and second open sub-superblocks are a superblock 1-1 and a superblock 3-2, respectively.

In step S904, the processor 134 may check the memory blocks included in the selected first and second sub-superblocks, respectively, based on the superblock table 600 and the sub-superblock table 700.

For example, referring to the superblock table 600, the first superblock may include the 11th, 21st, 31st, and 41st blocks Block11, Block21, Block31, and Block41. Referring to the sub-superblock table 700, the memory blocks included in the first to third planes Plane1 to Plane3 may constitute the first sub-superblock. Therefore, the superblock 1-1 may include the 11th, 21st, and 31st blocks Block11, Block21, and Block31 which are memory blocks included in the first to third planes, respectively, among the memory blocks included in the first superblock. Similarly, the superblock 3-2 may include the 43rd block Block43.

The processor 134 may access the 11th, 21st, and 31st blocks Block11, Block21, and Block31 in order of superpage in order to write the user data. The processor 134 may access the 43rd block Block43 in order of superpage, in order to write the metadata. The processor 134 may check which memory block to access, based on the superpage order and the sizes of the user data and metadata to be written.

In FIG. 10, shaded areas may indicate pages that the processor 134 accesses in order to write the user data and the metadata.

In step S906, the processor 134 may interleave the user data and the metadata, and provide a write command to the memory device 150. In the example of FIG. 10, the processor 134 may provide write commands to the first, second, and fourth dies Die1, Die2, and Die4, respectively.

In step S908, the memory device 150 may write the user data and the metadata to the first and second open sub-superblocks in parallel. Because the first and second sub-superblocks are constituted by memory blocks of different planes from each other, the user data and the metadata may be written in parallel. In the example of FIG. 10, the user data may be written to the second page Page2 of the 11th block Block11 and the second page Page2 of the 21st block Block22, which are included in the superblock 1-1, and the metadata may be written to the fourth page Page4 of the 43rd block Block43 included in the superblock 3-2. That is, the first and second planes Plane1 and Planet may write the user data, and the fourth plane Plane4 may write the metadata.

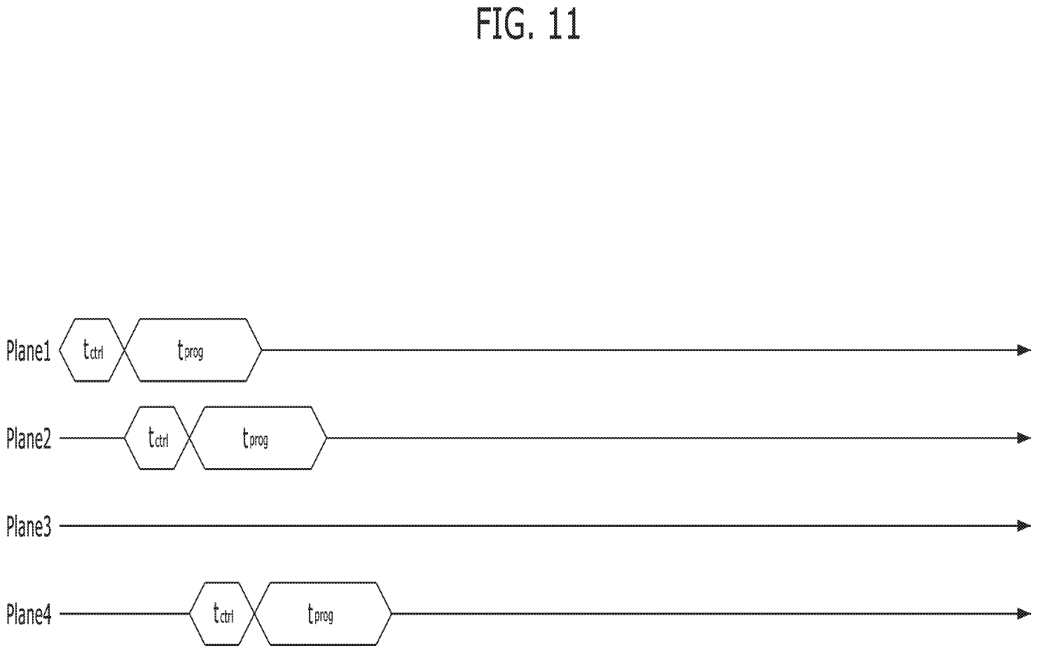

FIG. 11 is a timing diagram illustrating the operation of writing the user data and the metadata in accordance with the present embodiment.

Referring to FIG. 11, a time of 3t_{ctrl}+t_{prog} may be required to write the user data and the metadata. In general, a larger amount of time may be required for performing a write operation than a control signal transfer time. Therefore, compared to the timing diagram of FIG. 5 illustrating that the write operation is performed according to the related art, the user data and the metadata can be written within a shorter time when the write operation is performed in accordance with the present embodiment. Thus, the performance of the memory system 110 can be improved.

The metadata may also be written to different superblocks depending on the attributes of data. For example, map data and history data may be written to different superblocks. As described with reference to FIGS. 5 and 6, metadata having different attributes may be generated in response to one write request, and written to the same plane. When the metadata having different attributes are written to the same plane, the memory device 150 cannot write the metadata in parallel. Thus, the memory device 150 may not exhibit the parallel processing performance as much as is possible.

In accordance with an embodiment which is described below, the memory device 150 may write metadata having different attributes in parallel at the same time. Therefore, the parallel processing performance of the memory device 150 can be improved.

FIG. 12 illustrates a sub-superblock table 1200 in accordance with an embodiment. The sub-superblock table 1200 of FIG. 12 may correspond to the sub-superblock table of FIG. 1.

In accordance with an embodiment, a superblock may be handled as a full superblock or divided into first and second sub-superblocks. Information on whether each of the superblocks is handled as a full superblock or divided into sub-superblocks may be decided in advance. For superblocks divided into first and second sub-superblocks, memory blocks constituting the first and second sub-superblocks may be decided in advance.

The sub-superblock table 1200 may include the identifiers of the respective superblocks as indexes. Entries for each of the indexes may include a sub field for storing a bit value indicating whether the corresponding superblock is divided into sub-superblocks. In the example of FIG. 12, the first and second superblocks in which the bit values of the sub fields are ‘0’ may be handled as full superblocks. The third superblock in which the bit value of the sub field is ‘1’ may be divided into the first and second sub-superblocks.

The entries for each of the indexes of the superblocks divided into the first and second sub-superblocks may store bit values for distinguishing between the first and second sub-superblocks. For example, when a certain memory block constitutes the first sub-superblock, a bit value ‘0’ may be stored in the corresponding entry. When a certain memory block constitutes the second sub-superblock, a bit value ‘1’ may be stored in the corresponding entry.

In the example of FIG. 12, the memory blocks belonging to the first and second planes Plane1 and Planet may constitute the first sub-superblock, and the memory blocks belonging to the third and fourth planes Plane3 and Plane4 may constitute the second sub-superblock. For example, the 13th and 23rd blocks may constitute a superblock 3-1, and the 33rd and 43rd blocks may constitute a superblock 3-2.

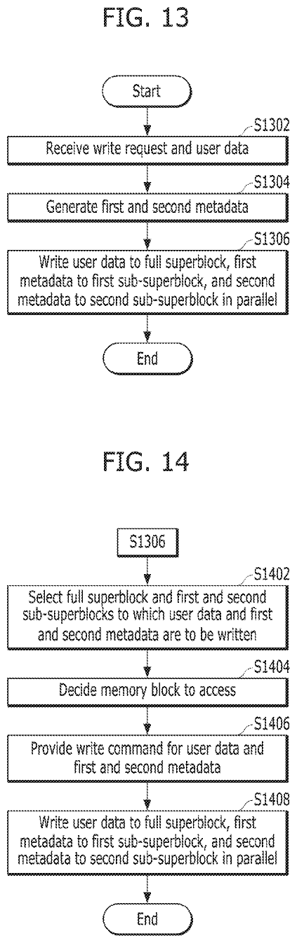

FIG. 13 is a flowchart illustrating an operation method of the memory system 110 in accordance with an embodiment.

In step S1302, the processor 134 may receive a write request and user data to be written from the host through the host I/F 132.

In step S1304, the processor 134 may generate first and second metadata associated with the user data.

In an embodiment, the first metadata may be map data, and the second metadata may be history data.

In step S1306, the processor 134 may interleave the user data and the first and second metadata such that the user data are written to a full superblock, the first metadata are written to a first sub-superblock, and the second metadata are written to a second sub-superblock, and provide a write command to the memory device 150. The memory device 150 may write the user data and the first and second metadata in response to the write command.

FIG. 14 is a flowchart illustrating detailed operations of step S1306.

In step S1402, the processor 134 may select the full superblock to which the user data are to be written and the first and second sub-superblocks to which the first and second metadata are to be written.

In step S1404, the processor 134 may check memory blocks included in the selected full superblock and the selected first and second sub-superblocks, respectively, based on the superblock table 600 and the sub-superblock table 1200.

The processor may perform write operations on the full superblock and the first and second sub-superblocks in order of superpage. The processor 134 may check which memory block to access, based on the superpage order and the sizes of the user data and metadata to be written.

In step S1406, the processor 134 may provide a write command to the memory device 150 in order to write the user data and the first and second metadata.

In step S1408, the memory device 150 may write the user data and the first and second metadata to the full superblock and the first and second open sub-superblocks, respectively. Because the first and second sub-superblocks are constituted by the memory blocks of different planes, the first and second metadata may be written in parallel.

In accordance with the present embodiment, the metadata having different attributes may be written in parallel in different planes. Therefore, the parallel processing performance of the memory device 150 can be improved.

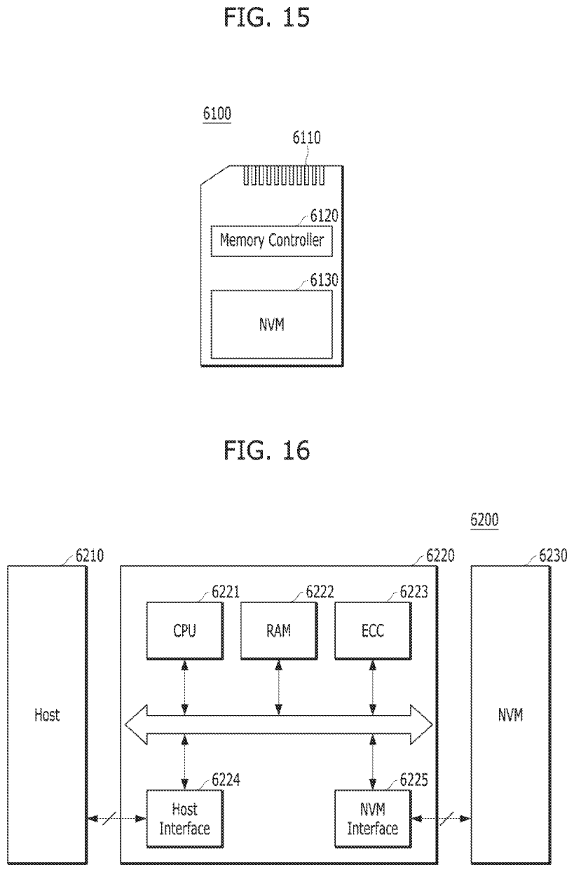

FIGS. 15 to 23 are diagrams schematically illustrating application examples of the data processing system of FIGS. 1 to 14 according to various embodiments.

FIG. 15 is a diagram schematically illustrating the data processing system including the memory system in accordance with an embodiment. FIG. 15 schematically illustrates a memory card system 6100 to which the memory system is applied.

Referring to FIG. 15, the memory card system 6100 may include a memory controller 6120, a memory device 6130, and a connector 6110.

More specifically, the memory controller 6120 may be connected to the memory device 6130 embodied by a nonvolatile memory (NVM), and configured to access the memory device 6130. For example, the memory controller 6120 may be configured to control read, write, erase, and background operations of the memory device 6130. The memory controller 6120 may be configured to provide an interface between the memory device 6130 and a host (not shown), and drive firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

Thus, as shown in FIG. 1, the memory controller 6120 may include a random access memory (RAM), a processor, a host interface, a memory interface, and an error correction component.

The memory controller 6120 may communicate with an external device, for example the host 102 of FIG. 1, through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (Wi-Fi or WiFi), and Bluetooth. Thus, the memory system and the data processing system in accordance with an embodiment may be applied to wired and/or wireless electronic devices or particularly mobile electronic devices.

The memory device 6130 may be implemented by a nonvolatile memory. For example, the memory device 6130 may be implemented by any of various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM), and a spin torque transfer magnetic RAM (STT-RAM).

The memory controller 6120 and the memory device 6130 may be integrated into a single semiconductor device. For example, the memory controller 6120 and the memory device 6130 may be integrated to form a solid-state driver (SSD). Also, the memory controller 6120 and the memory device 6130 may form a memory card such as a PC card (e.g., Personal Computer Memory Card International Association (PCMCIA)), a compact flash (CF) card, a smart media card (e.g., SM and SMC), a memory stick, a multimedia card (e.g., MMC, RS-MMC, MMCmicro and eMMC), an secured digital (SD) card (e.g., SD, miniSD, microSD and SDHC), and a universal flash storage (UFS).

FIG. 16 is a diagram schematically illustrating another example of a data processing system 6200 including the memory system in accordance with an embodiment.

Referring to FIG. 16, the data processing system 6200 may include a memory device 6230 having one or more nonvolatile memories (NVMs) and a memory controller 6220 for controlling the memory device 6230. The data processing system 6200 may serve as a storage medium such as a memory card (CF, SD, micro-SD, or the like) or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write, or erase operation on the memory device 6230 in response to a request of the host 6210, and the memory controller 6220 may include one or more central processing units (CPUs) 6221, a buffer memory such as a random access memory (RAM) 6222, an error correction code (ECC) circuit 6223, a host interface 6224, and a memory interface such as an NVM interface 6225.

The CPU 6221 may control overall operations on the memory device 6230, for example, read, write, file system management, and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the memory device 6230 to operate at high speed.

The ECC circuit 6223 may generate an error correction code (ECC) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. The ECC circuit 6223 may correct an error using the parity bit. For example, the ECC circuit 6223 may correct an error using Low Density Parity Check (LDPC) code, Bose-Chaudhri-Hocquenghem (BCH) code, turbo code, Reed-Solomon code, convolution code, Recursive Systematic Code (RSC), or coded modulation such as Trellis-Coded Modulation (TCM) or Block coded modulation (BCM).

The memory controller 6220 may transmit and/or receive data to and/or from the host 6210 through the host interface 6224, and transmit/receive data to/from the memory device 6230 through the NVM interface 6225. The host interface 6224 may be connected to the host 6210 through a parallel advanced technology attachment (PATA) bus, serial advanced technology attachment (SATA) bus, small computer system interface (SCSI), universal serial bus (USB), peripheral component interconnect-express (PCIe), or NAND interface. The memory controller 6220 may have a wireless communication function with a mobile communication protocol such as wireless fidelity (WiFi) or Long Term Evolution (LTE). The memory controller 6220 may be connected to an external device, for example, the host 6210 or another external device, and then transmit and/or receive data to and/or from the external device. In particular, as the memory controller 6220 is configured to communicate with the external device through one or more of various communication protocols, the memory system and the data processing system in accordance with an embodiment may be applied to wired and/or wireless electronic devices or particularly a mobile electronic device.

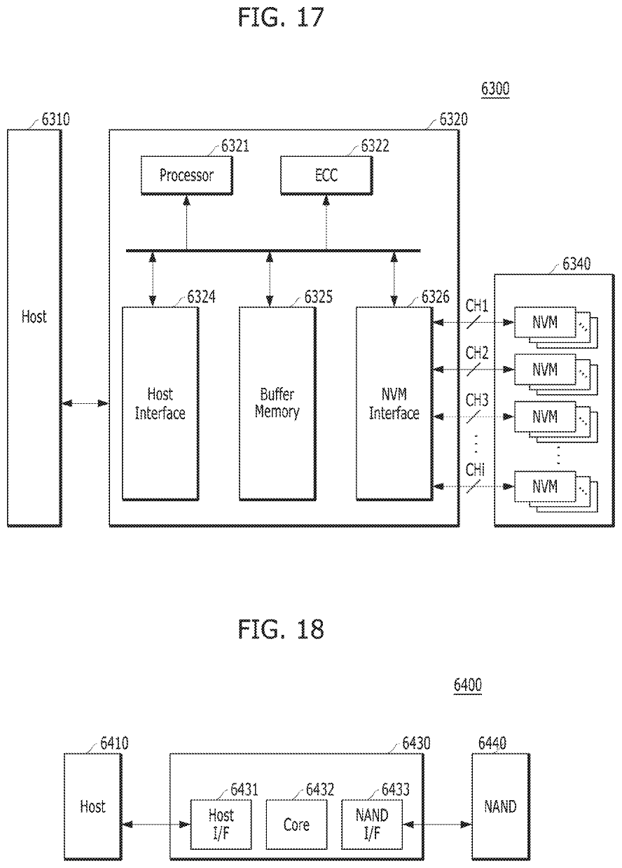

FIG. 17 is a diagram schematically illustrating another example of the data processing system including the memory system in accordance with an embodiment. FIG. 17 schematically illustrates a solid state drive (SSD) 6300 to which the memory system may be applied.

Referring to FIG. 17, the SSD 6300 may include a controller 6320 and a memory device 6340 including a plurality of nonvolatile memories (NVMs). The controller 6320 may correspond to the controller 130 in the memory system 110 of FIG. 1, and the memory device 6340 may correspond to the memory device 150 in the memory system of FIG. 1.

More specifically, the controller 6320 may be connected to the memory device 6340 through a plurality of channels CH1 to CHi. The controller 6320 may include one or more processors 6321, an error correction code (ECC) circuit 6322, a host interface 6324, a buffer memory 6325, and a memory interface, for example, a nonvolatile memory interface 6326.

The buffer memory 6325 may temporarily store data provided from the host 6310 or data provided from a plurality of flash memories NVM included in the memory device 6340, or temporarily store metadata of the plurality of flash memories NVM, for example, map data including a mapping table. The buffer memory 6325 may be embodied by volatile memories such as dynamic random access memory (DRAM), synchronous DRAM (SDRAM), double data rate (DDR) SDRAM, low power DDR (LPDDR) SDRAM, and graphics RAM (GRAM) or nonvolatile memories such as ferroelectric RAM (FRAM), resistive RAM (RRAM or ReRAM), spin-transfer torque magnetic RAM (STT-MRAM), and phase-change RAM (PRAM). For convenience of description, FIG. 17 illustrates that the buffer memory 6325 exists in the controller 6320. However, the buffer memory 6325 may exist outside the controller 6320 in other embodiments.

The ECC circuit 6322 may calculate an error correction code (ECC) value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, a redundant array of independent disks (RAID) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 18 is a diagram schematically illustrating another example of the data processing system including the memory system in accordance with an embodiment. FIG. 18 schematically illustrates an embedded Multi-Media Card (eMMC) 6400 to which the memory system may be applied.

Referring to FIG. 18, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

More specifically, the controller 6430 may be connected to the memory device 6440 through a plurality of channels. The controller 6430 may include one or more cores 6432, a host interface (I/F) 6431, and a memory interface, for example, a NAND interface (I/F) 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, Ultra High Speed (UHS)-I and UHS-II interface.

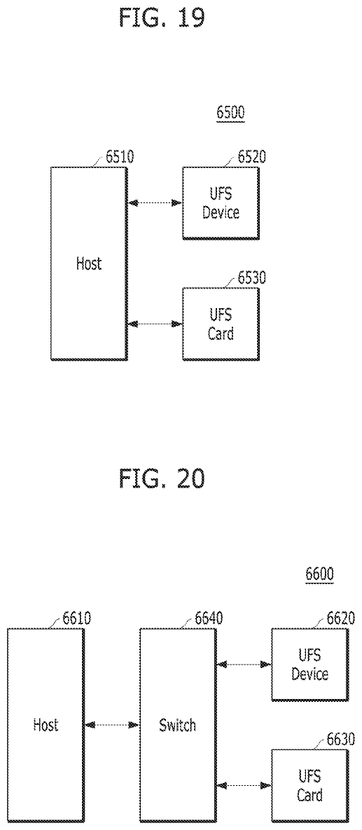

FIGS. 19 to 22 are diagrams schematically illustrating other examples of the data processing system including the memory system in accordance with one or more embodiments. FIGS. 19 to 22 schematically illustrate universal flash storage (UFS) systems to which the memory system may be applied.

Referring to FIGS. 19 to 22, the UFS systems 6500, 6600, 6700, and 6800 may include hosts 6510, 6610, 6710, and 6810, UFS devices 6520, 6620, 6720, and 6820 and UFS cards 6530, 6630, 6730, and 6830, respectively. The hosts 6510, 6610, 6710, and 6810 may serve as application processors of wired and/or wireless electronic devices or particularly mobile electronic devices, the UFS devices 6520, 6620, 6720, and 6820 may serve as embedded UFS devices. The UFS cards 6530, 6630, 6730, and 6830 may serve as external embedded UFS devices or removable UFS cards.

The hosts 6510, 6610, 6710, and 6810, the UFS devices 6520, 6620, 6720, and 6820 and the UFS cards 6530, 6630, 6730, and 6830 in the respective UFS systems 6500, 6600, 6700, and 6800 may communicate with external devices, for example, wired and/or wireless electronic devices or particularly mobile electronic devices through UFS protocols. The UFS devices 6520, 6620, 6720, and 6820 and the UFS cards 6530, 6630, 6730, and 6830 may be embodied by the memory system 110 illustrated in FIG. 1. For example, in the UFS systems 6500, 6600, 6700, and 6800, the UFS devices 6520, 6620, 6720, and 6820 may be embodied in the form of the data processing system 6200, the SSD 6300 or the eMMC 6400 described with reference to FIGS. 16 to 18, and the UFS cards 6530, 6630, 6730, and 6830 may be embodied in the form of the memory card system 6100 described with reference to FIG. 15.

Furthermore, in the UFS systems 6500, 6600, 6700, and 6800, the hosts 6510, 6610, 6710, and 6810, the UFS devices 6520, 6620, 6720, and 6820 and the UFS cards 6530, 6630, 6730, and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, and 6820 and the UFS cards 6530, 6630, 6730, and 6830 may communicate with each other through various protocols other than the UFS protocol, for example, universal storage bus (USB) Flash Drives (UFDs), multi-media card (MMC), secure digital (SD), mini-SD, and micro-SD.

In the UFS system 6500 illustrated in FIG. 19, each of the host 6510, the UFS device 6520, and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. The UFS device 6520 and the UFS card 6530 may communicate with each other through link layer switching at the UniPro of the host 6510. In an embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6510, and a plurality of UFS cards may be connected in parallel or in the form of a star to the UFS device 6520 or connected in series or in the form of a chain to the UFS device 6520.

In the UFS system 6600 illustrated in FIG. 20, each of the host 6610, the UFS device 6620, and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In an embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

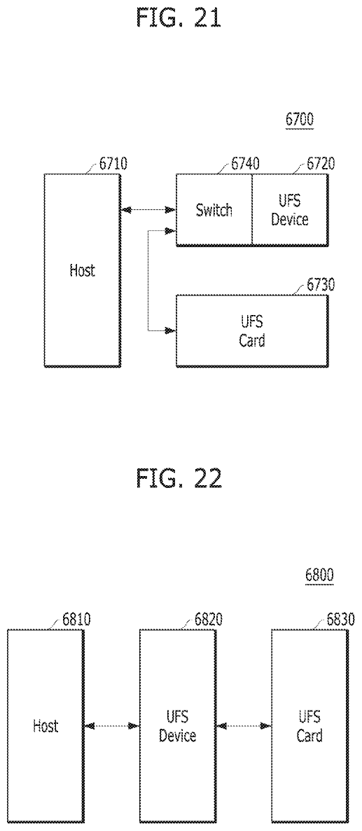

In the UFS system 6700 illustrated in FIG. 21, each of the host 6710, the UFS device 6720, and the UFS card 6730 may include UniPro. The host 6710 may communicate with the UFS device 6720 or the UFS card 6730 through a switching module 6740 performing a switching operation, for example, through the switching module 6740 which performs link layer switching at the UniPro, for example, L3 switching. The UFS device 6720 and the UFS card 6730 may communicate with each other through link layer switching of the switching module 6740 at the UniPro, and the switching module 6740 may be integrated as one module with the UFS device 6720 inside or outside the UFS device 6720. In an embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 22, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target Identifier (ID) switching operation. The host 6810 and the UFS card 6830 may communicate with each other through target ID switching between the M-PHY and UniPro modules of the UFS device 6820. In an embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

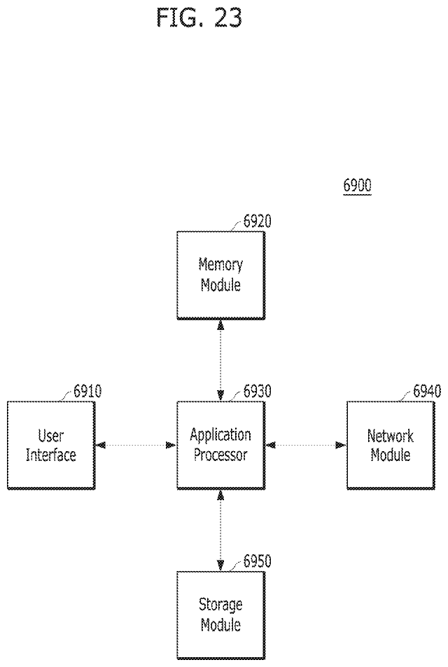

FIG. 23 is a diagram schematically illustrating another example of the data processing system including the memory system in accordance with an embodiment. FIG. 23 is a diagram schematically illustrating a user system 6900 to which the memory system may be applied.

Referring to FIG. 23, the user system 6900 may include a user interface 6910, a memory module 6920, an application processor 6930, a network module 6940, and a storage module 6950.

More specifically, the application processor 6930 may drive components included in the user system 6900, for example, an operating system (OS), and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile random access memory (RAM) such as a dynamic RAM (DRAM), a synchronous DRAM (SDRAM), a double data rate (DDR) SDRAM, DDR2 SDRAM, DDR3 SDRAM, LPDDR SDARM, LPDDR3 SDRAM, or LPDDR3 SDRAM or a nonvolatile RAM such as a phase-change RAM (PRAM), a resistive RAM (ReRAM), a magneto-resistive RAM (MRAM), or a ferroelectric RAM (FRAM). For example, the application processor 6930 and the memory module 6920 may be packaged and mounted, based on Package on Package (PoP).

The network module 6940 may communicate with external devices. For example, the network module 6940 might not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash, and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 17 to 22.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor, and a piezoelectric element, and user output interfaces such as a liquid crystal display (LCD), an organic light emitting diode (OLED) display device, an active matrix OLED (AMOLED) display device, an LED, a speaker, and a monitor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired and/or wireless communication with an external device. The user interface 6910 may display data processed by the processor 6930 on a display/touch module of the mobile electronic device, or support a function of receiving data from the touch panel.

In accordance with presented embodiments, it is possible to provide a memory system capable of improving interleaving performance of a superblock, and an operation method thereof.

Although various embodiments have been described for illustrative purposes, it will be apparent to those skilled in the art that various changes and modifications may be made without departing from the spirit and scope of the present teachings as defined in the following claims.

What is claimed is:

1. A memory system comprising:
a memory device comprising a plurality of superblocks, wherein each superblock comprises first and second sub-superblocks; and
a controller suitable for controlling the memory device, wherein the controller comprises a processor suitable for controlling the memory device to write data having different attributes to the first and second sub-superblocks in parallel.

2. The memory system of claim 1, wherein the controller further comprises a host interface suitable for receiving a write request and user data from the host, and
wherein the processor is suitable for generating metadata associated with the user data and controlling the memory device to write the user data to the first sub-superblock and write the metadata to the second sub-superblock in parallel.

3. The memory system of claim 2, wherein the controller further comprises a memory suitable for storing a sub-superblock table including information for dividing each of the plurality of superblocks into the first and second sub-superblocks based on planes.

4. The memory system of claim 3, wherein the memory is further suitable for storing a superblock table including information on memory blocks constituting the superblock for the respective planes.

5. The memory system of claim 4, wherein the processor provides write commands to planes corresponding to memory blocks constituting the first and second sub-superblocks, respectively, by referring to the superblock table and the sub-superblock table, and controls the memory device to write the user data and the metadata in parallel.

6. The memory system of claim 1, wherein the memory device further comprises a plurality of full superblocks.

7. The memory system of claim 6, wherein the controller further comprises a host interface suitable for receiving a write request and user data from the host, and
wherein the processor is further suitable for generating first metadata and second metadata associated with the user data and for controlling the memory device to write the user data to the full superblock, write the first metadata to the first sub-superblock, and write the second metadata to the second sub-superblock in parallel.

8. The memory system of claim 7, wherein the controller further comprises a memory suitable for storing a sub-superblock table including information for handling each of the plurality of superblocks as a full superblock or divided into first and second sub-superblocks based on planes and identifiers of the superblocks.

9. The memory system of claim 8, wherein the memory is further suitable for storing a superblock table including information on memory blocks constituting the superblock for the respective planes.

10. The memory system of claim 9, wherein the processor is further suitable for providing write commands to planes corresponding to memory blocks constituting the full superblock and the first and second sub-superblocks, respectively, by referring to the sub-superblock table and the superblock table, and for controlling the memory device to write the user data to the full superblock, write the first metadata to the first sub-superblock, and write the second metadata to the second sub-superblock in parallel.

11. An operation method of a memory system including a memory device comprising a plurality of superblocks, wherein each superblock comprises first and second sub-superblocks, the operation method comprising:
receiving a write request and user data from a host;
generating metadata associated with the user data;
writing the user data to the first sub-superblock; and
writing the metadata to the second sub-superblock, wherein the user data and the metadata are written in parallel.

12. The operation method of claim 11, wherein writing the user data to the first sub-superblock and writing the metadata to the second sub-superblock in parallel comprises:
selecting a first sub-superblock and a second sub-superblock;
providing write commands to planes corresponding to memory blocks constituting the first and second sub-superblocks, respectively, by referring to a superblock table and a sub-superblock table; and
writing the user data and the metadata such that at least a portion of the user data is written at the same time as the metadata is being written.

13. The operation method of claim 12, wherein the sub-superblock table comprises information for dividing each of the superblocks into the first and second sub-superblocks based on planes.

14. The operation method of claim 12, wherein the superblock table comprises information on memory blocks constituting a superblock for the respective planes.

15. An operation method of a memory system including a memory device comprising a plurality of superblocks, wherein each of the superblocks handled as a full superblock or comprising first and second sub-superblocks, the operation method comprising:
receiving a write request and user data from a host;
generating first metadata and second metadata, which are associated with the user data; and
writing, in parallel, the user data to the full superblock, the first metadata to the first sub-superblock, and the second metadata to the second sub-superblock.

16. The operation method of claim 15, wherein writing, in parallel, the user data to the full superblock, the first metadata to the first sub-superblock, and the second metadata to the second sub-superblock comprises:
selecting the full superblock and the first and second sub-superblocks;
providing write commands to planes corresponding to memory blocks constituting the full superblock and the first and second sub-superblocks, respectively, by referring to a superblock table and a sub-superblock table; and
writing, by the planes, the user data and the first and second metadata in response to the write commands.

17. The operation method of claim 16, wherein the sub-superblock table comprises information for handling each of the superblocks as full superblocks or divided into the first and second sub-superblocks based on the planes and identifiers of the superblocks.

18. The operation method of claim 16, wherein the superblock table comprises information on memory blocks constituting a superblock for the respective planes.
